(19) United States
(12) Patent Application Publication
(10) Pub. No.: US 2007/0293220 A1
(43) Pub. Date: Dec. 20, 2007

(54) System, method and handset for sharing a call in a VoIP system

(75) Inventors: Jerry J. Mahler, Hoffman Estates, IL (US); Hui Dai, Itasca, IL (US); Yingchun Xu, Madison, WI (US)

Correspondence Address: MH2 TECHNOLOGY LAW GROUP, LLP, 1951 KIDWELL DRIVE, SUITE 550, TYSONS CORNER, VA, 22182, US

(73) Assignee: MOTOROLA, INC.

(21) Appl. No.: 11/455,667

(22) Filed: Jun. 20, 2006

(51) Int. Cl. H04Q 7/20

(52) U.S. Cl. 455/435.1

(57) ABSTRACT

An embodiment generally relates a method of joining a call. The method includes establishing the call between an internal mobile terminal (MT), an external MT, and a network access point (NAP). The call comprises a connection between the internal MT and the NAP and a second connection between the NAP and the external MT. The method also includes sensing the call by a second internal MT and joining the call from the second internal MT by depressing a send key without entering a number on the second internal MT.

### FIELD

This invention relates generally to a voice over IP (VoIP) system, more particularly to system, method and a handset for sharing a call in the VoIP system.

### DESCRIPTION OF THE RELATED ART

VoIP is a technology that has the potential to completely rework the world's phone systems. VoIP providers like Vonage have already been around for a little while and are growing steadily. Major carriers like AT&T are already setting up VoIP calling plans in several markets around the United States, and the FCC is looking seriously at the potential ramifications of VoIP service.

VoIP may be accomplished in several ways. VoIP may be implemented using ATA, IP telephones, and computer-to-computer. Analog telephone adaptor (ATA) may be the simplest and most common way to implement VoIP. The ATA allows you to connect a standard phone to your computer or your Internet connection for use with VoIP. The ATA is an analog-to-digital converter. It takes the analog signal from your traditional phone and converts it into digital data for transmission over the Internet.

A second way to implement VoIP is with IP telephones. These specialized phones look just like normal phones with a handset, cradle and buttons. But instead of having the standard RJ-11 phone connectors, IP phones have an RJ-45 Ethernet connector. IP phones connect directly to your router and have all the hardware and software necessary right onboard to handle the IP call.

Yet another way to implement VoIP is by computer-to-computer. This is certainly the easiest way to use VoIP. VoIP software, a microphone, speakers, a sound card and an Internet connection. Except for your normal monthly ISP fee, there is usually no charge for computer-to-computer calls, no matter the distance.

Despite the enhanced features and convenience of the VoIP systems, they cannot provide all the features used by PSTN telephones. For example, the PSTN telephones have a shared line feature where if a PSTN within a house is engaged in a call, another user may join the call by picking up another extension. For VoIP telephones to implement the same feature may involve establishing a conference call-between the parties because VoIP are essentially peer-to-peer systems. A user may be unwilling to allow a third party to join the call because of the setup process for the conference. Moreover, the shared line feature of the PSTN telephones has at least one drawback. If a call is on-going, a third party may surreptitiously join the call without the original parties knowing of the intrusion.

### SUMMARY

An embodiment generally relates a method of joining a call. The method includes establishing the call between an internal mobile terminal (MT), an external MT, and a network access point (NAP). The call comprises a connection between the internal MT and the NAP and a second connection between the NAP and the external MT. The method also includes sensing the call by a second internal MT and joining the call from the second internal MT by depressing a send key without entering a number on the second internal MT.

Another embodiment pertains generally to a system for sharing a line in a voice over Internet Protocol (VoIP). The system includes a network access point (NAP) within a site and a plurality of internal mobile terminals (MTs) located within the site and within the range of the NAP. Each MT is configured to communicate using VoIP. The system also includes at least one external MT configured to communicate with the internal MTs. The system is configured to establish a call between a first internal MT and the at least one external MT through the NAP and set a send key to call the NAP in each of the rest of the plurality of internal MT in response to the establishment of the call. The system may join a second internal MT to the call in response to depressing the send key on the second internal MT.

Yet another embodiment relates generally a handset configured for sharing a line in a voice over Internet Protocol (VoIP) system. The handset includes a transceiver configured to interface with an access cell of a mobile communication system and a network access point (NAP), a user interface with a transmit key; and a processor configured to execute a shared line module. The processor is configured to determine from the NAP that a call-in-progress and set the NAP as a default number for the transmit key. The processor joins the call-in-progress in response to activating the transmit key.

Accordingly, the shared line feature of the PSTN telephones may be mimicked in VoIP systems for mobile terminals within a site. The user may benefit from the ease of pressing one key to join a call as current users of cordless telephone joining a call in the PSTN system.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1A illustrates an exemplary mobile terminal in accordance with an embodiment;

FIG. 1A illustrate an exemplary user interface and display of the mobile terminal shown in FIG. 1A;

FIG. 2 illustrates an exemplary network access point in accordance with another embodiment;

FIG. 3 illustrates an exemplary call flow diagram in accordance with yet another embodiment;

FIG. 4 illustrates an exemplary system in accordance with yet another embodiment;

FIGS. 5A-B collectively illustrate an exemplary call flow diagram in accordance with yet another embodiment;

FIG. 5C illustrates a state of the LCD display in accordance with yet another embodiment;

FIG. 6A illustrates another exemplary flow diagram in accordance with yet another embodiment;

FIGS. 6B-C each illustrates different states of the LCD display in accordance with yet another embodiment; and

FIG. 7 illustrates yet another exemplary flow diagram in accordance with yet another embodiment.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of mobile communication systems, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Various embodiments generally relate to systems and methods for providing shared lines feature for voice over internet protocol (VoIP) systems. For these embodiments, a shared line feature in PSTN may be described as the situation where a PSTN telephone user may be engaged in a call with an outside user and a second PSTN telephone as an extension goes off-hook to join the existing call.

Accordingly, embodiments generally pertain to systems and methods of implementing a shared line feature for voice-over-Internet-Protocol (VoIP). More specifically, a communication system may include a network access point (NAP), Internet, mobile communication system, and mobile terminals (MTs) with VoIP capabilities. The NAP may be located in a site. The NAP may be accessible to PSTN telephones as well as to MTs that are within the confines of the site. The NAP may connect to other mobile communication systems, landline communication systems and/or data network systems.

A shared line module executing on a mobile terminal may be configured to implement the shared line feature within a site serviced by a NAP. More specifically, embodiments of the shared line module may be configured to detect whether the MT is within a site (or internal), i.e., within range of the NAP. If MT is within the site (an internal MT), the shared line module may be configured to route VoIP calls to/from the site through the NAP. For outgoing calls, the internal MT may call an external mobile terminal that is located outside of the site. Since the internal MT is within the site, the internal MT connects with the NAP over a VoIP connection. The NAP, in turn, may connect with the external MT over a second VoIP connection. Similarly, when the external MT attempts to call the internal MT, the internal MT knowing that is within the site may redirect the incoming call to the NAP. The NAP may be configured to connect with the external user over a first VoIP connection. The NAP then calls the internal MT and forms a second VoIP connection. In either case, the NAP has placed itself between the two MTs and functions as a back-to-back user agent (B2BUA).

A second internal MT may seamlessly join the existing call between the first internal and external MTs. More specifically, since the shared line module of the second internal MT has determined that it is within the site, the shared line module of the second internal MT has set the default for the send key for the NAP. Accordingly, the second internal MT may join the existing conversation by calling pressing a send key (or a soft key for the purpose of joining the conversation, some other key, a combination of keys, or other pre-defined user input), which calls the NAP. The NAP may be configured to conference all three MTs once the connection to the NAP and the second internal mobile user is established.

A PSTN telephone may also participate in the shared line features of this VoIP system. More particularly, the PSTN may be interfaced with the NAP through an analog telephone connector (ATA). When a user of the PSTN goes off-hook, the ATA calls the NAP and forms a VoIP connection. The NAP may then conference the PSTN user with the existing conversation.

Other embodiments include a privacy button. More particularly, one of the MTs may be engaged to invoke a privacy button. The activation of the privacy button configures the NAP not to accept any calls from within the site. Accordingly, any MTs or landline telephones within the site could not join the existing call.

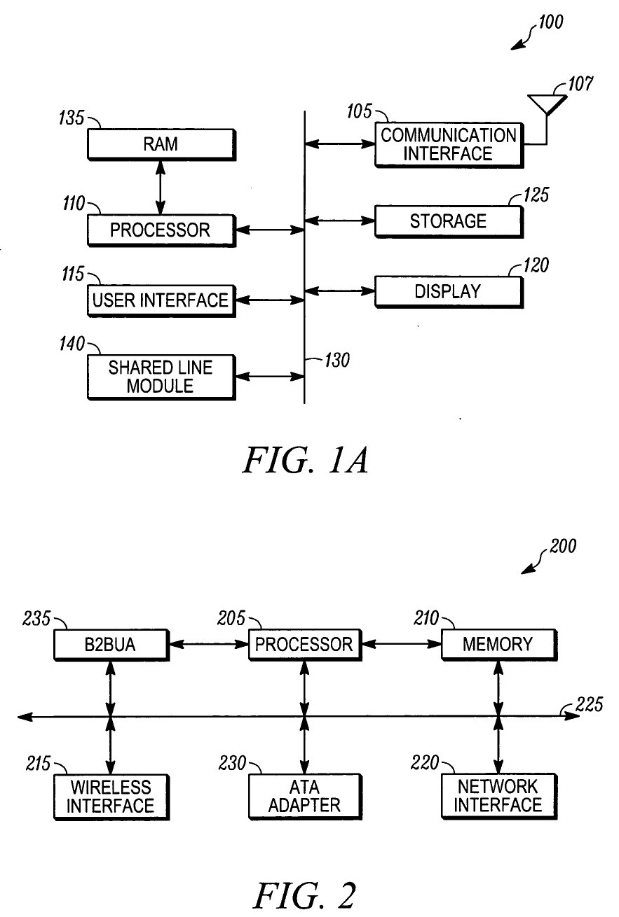

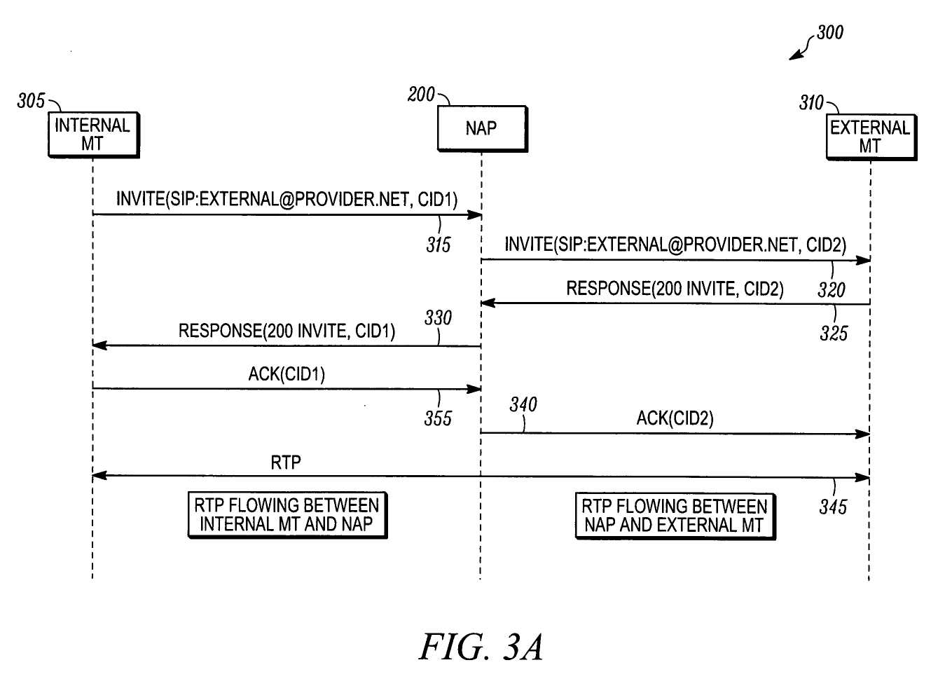

FIG. 1A illustrates an exemplary embodiment of a mobile terminal 100 in accordance with an embodiment. It should be readily apparent to those of ordinary skill in the art that the mobile terminal 100 depicted in FIG. 1 represents a generalized schematic illustration and that other components may be added or existing components may be removed or modified. Moreover, the mobile terminal 100 may be implemented using software components, hardware components, or combinations thereof.

As shown in FIG. 1A, the mobile terminal (communication device, dual-mode cellular telephone, etc.) 100 may include a communication interface 105, a processor 110, a user interface 115, a display module 120, and storage 125. The wireless communication interface 105 (labeled as communication interface in FIG. 1) may be configured to facilitate communication over-an-air interface with a base station of a cellular network that supports voice-over-IP (“VoIP”) such as the iDen™ network. More particularly, the communication interface 105 may transmit and receive digital voice packets through a radio frequency (RF) antenna 107. The communication interface 105 may also be configured to interface with a shared bus 130. Transmitting voice packets may be forwarded from the user interface 115 to the communication interface 105 over the shared bus 130 as well as received voice packets forwarded to the user interface 115 over the shared bus 130.

Processor 110 may be configured to interface with the shared bus 130. The processor 110 may be configured to implement the software that embodies the functionality of the mobile terminal 100, which may be stored in random access memory 135 (labeled as RAM in FIG. 1A). The RAM 135 may be programmable read only memory, flash memory or similar type of high speed persistent storage. Processor 110 may be an application specific integrated circuit, programmable field gate array, a microprocessor, digital signal processor or similar type of computing platform.

Storage 125 may be configured to store information for a user of the mobile terminal 100. For example, a contact list, downloaded music, digital images maybe stored in storage 125. The storage 125 may be implemented using a persistent storage such as flash memory. In some embodiments, the storage function of the RAM 135 may be provided by storage 125.

User interface 115 may be configured to interface with the shared bus 130. The user interface 115 may also be configured to facilitate interaction with a user. As such, the user interface 115 may include media input and output mechanisms. For example, to facilitate voice communications, these mechanisms may include a microphone (not shown) for receiving analog speech signals from a user and a speaker (not shown) for playing out analog speech signals to a user. Further, the mobile terminal 100 may include digital/analog media signals and digital representations of those signals, for example, soft button on a keyless display.

The user interface 115 may also include a keypad 150 shown in FIG. 1B. As shown in FIG. 1B, the keypad 150 may be a Bell keypad for numbers 1-10 along with a character * and a character # in a 3×4 matrix where the keypads for 1, 2, and 3 are on the top-row. The keypad 150 may also include a SEND key 155 and an END key 160. The SEND key 155 may be configured to initiate a telephone call for an entered telephone number and/or person. In a default setting, the SEND key 155 may be configured to wait for a user to enter a telephone number and then initiate the call when the user activates the “SEND” key. Otherwise, the mobile terminal 100 may display an error for not entering a telephone number or a contact name. The END key 160 may be configured to terminate a call, where the call may be cellular and/or VoIP call.

The keypad 150 may also include two programmable keys 165, 170 may be configured to interface with programmable fields 175, 180 respectively, on the LCD display 120. More specifically, the mobile terminal (MT) 100 may be configured with various functions such as video capture, image capture, contact manager, text messaging, music playing, etc. For example, the default dialing application executing on the MT 100, programmable field 175 may display the text “DELETE” to allow the user to delete one character by activating programmable key 165. In some embodiments, the keypad 150 may be emulated on the display 120 and may also be a QWERTY keyboard or other keyboard layout.

Returning to FIG. 1A, in accordance with various embodiments, the processor 110 may configured to execute a shared line module 140. The shared line module 140 may be a computer program embodiment of the functionality for sharing a line in a home, business, location, etc. As depicted, the shared line module 140 is a separate component. However, it should be readily obvious that the functionality of the shared line module 140 may be implemented as sub-module, subroutine, or applet executed by the processor 110 and stored in the RAM 135 or storage 125.

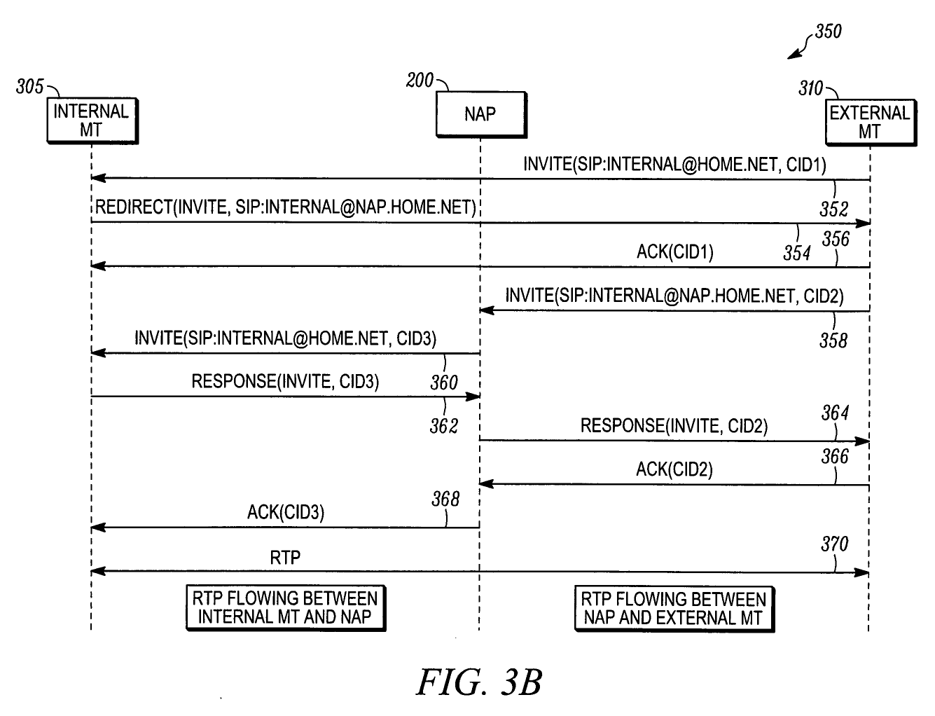

The shared line module 140 may be configured to implement the shared line feature in conjunction with a NAP 200, which is illustrated in FIG. 2. More specifically, embodiments of the shared line module 140 may be configured to detect whether a MT 100 within a site, i.e., within range of the NAP 200. If the MT 100 is within the site (internal MT), the shared line module 140 may be configured to route VoIP calls to/from the site through the NAP 200. For outgoing calls, the internal MT 100 may call an external mobile terminal that is located outside of the site. Since the internal MT 100 is within the site, the internal MT 100 may forward a message to the NAP 200 to use a back-to-back user agent (“B2BUA”) functionality to connect a call between the internal MT 100 as a user agent and the external MT as a second user agent. Similarly, when an external MT attempts to call the internal MT 100, the internal MT 100 may transmit a message for the B2BUA of the NAP 200 to connect the external MT and the internal MT 100.

A second internal MT may seamlessly join the existing the call between the first internal and external MTs. More specifically, since the shared line module 140 of the second internal MT has determined that it is within the site, the shared line module 140 of the second internal MT has set the default phone number for the send key as the NAP 200. Accordingly, the second internal MT may join the existing conversation by calling pressing a SEND key (e.g., see 155 of FIG. 1B), which calls the NAP 200. The NAP 200 may be configured to conference all three MTs once the connection to the NAP 200 and the second internal MT.

A PSTN telephone may also participate in the shared line features of this VoIP system. More particularly, the PSTN telephone may be interfaced with the NAP 200 through an analog telephone connector (ATA). When a user of the PSTN telephone goes off-hook, the ATA and the NAP 200 forms a VoIP connection. The NAP 200 may then conference the PSTN user with the existing conversation.

FIG. 2 illustrates an exemplary NAP 200 in accordance with yet another embodiment. It should be readily apparent to those of ordinary skill in the art that the NAP 200 depicted in FIG. 2 represents a generalized schematic illustration and that other components may be added or existing components may be removed or modified. Moreover, the NAP 200 may be implemented using software components, hardware components, or combinations thereof.

As shown in FIG. 2, the NAP 200 may include a processor 205, a storage module 210, a wireless interface, a network interface 220 and a shared bus 225. The processor 205 may be configured to provide the computing platform to execute the functionality of the NAP 200. The functionality of the NAP 200 may be stored on the storage module 210. The storage module 210 may also be configured to provide memory space for applications executing on the processor 205. The processor 205 may be implemented using a microprocessor, a digital signal processor, an application specific integrated circuit, a field programmable gate array, or other similar programmable devices. The storage module 210 may be implemented with a persistent high speed memory such as a flash memory, PROM, or other similar type of memory. In some embodiments, the processor 205 and the memory 210 may be merged as a single component.

The wireless interface 215 may be configured to detect for MT terminals to route VoIP or other type of SIP services through the NAP 200. The wireless interface 215 may be configured to have a limited range within a location, i.e., a home, an office, etc. The wireless interface 215 may convert wireless voice/command packets from MT 100 into wired voice/command/data packets for the NAP 200 and convert voice/command/data packets from NAP 200 into wireless voice/command/data packets to the MT 100.

The network interface 220 may be configured to connect the NAP 200 to a data network (not shown). The data network may be a local area network, a wide area network, the Internet or a combination thereof. The network interface 220 may provide a mechanism for two-way traffic of voice/command/data packets between the MTs within the coverage zone of the NAP 200 and another party on the data network.

The shared bus 225 may provide a communication channel for the voice/command/data packets for the wireless interface 215 and network interface 220. The processor 205 may provide processing of packets with regard to address or formatting to the appropriate network protocol.

The NAP 200 may also include a B2BUA module 235 (labeled as B2BUA in FIG. 2). The B2BUA module 235 may be configured to take an end-to-end call and mediates the call through the NAP 200. With the B2BUA module 235, the NAP 200 may become an active participant in the call from beginning to end as all signaling messages pass through and are processed by the B2BUA at all times. A B2BUA maintains call state and actively participates in sending requests and responses for dialogs in which it is involved. More specifically, the B2BUA may be considered a logical entity that receives requests as a user agent server (UAS) and, in order to respond to them, acts as a user agent client (UAC) and generates requests. Additionally it maintains dialog state and must participate in all of the requests sent on the dialogs it has established. The B2BUA has additional functionality as described in RFC#3725, “Best Current Practices for Third Party Call Control (3PCC) in the Session Initiation Protocol (SIP),” IETF, April 2004, which is hereby incorporated in its entirety by reference.

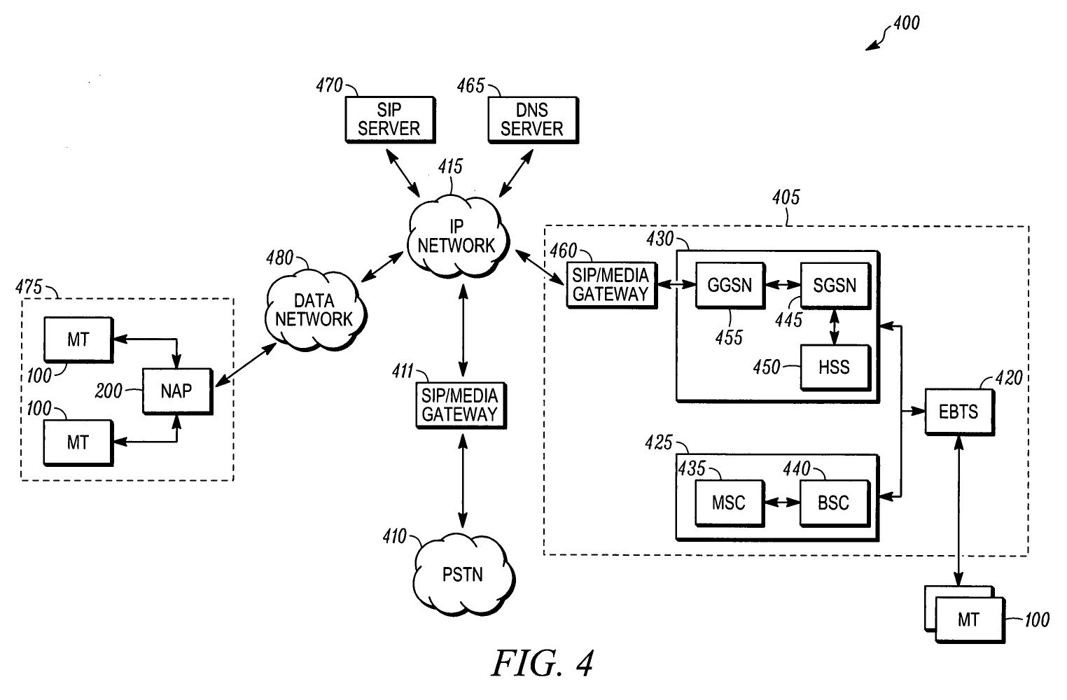

In various embodiments, the B2BUA module 235 may be configured to implement a VoIP shared line feature that mimics the PSTN line sharing and connect calls (or sessions) between mobile terminals, as illustrated by the call flow 300 shown in FIG. 3A. The internal MT 305 and external MT 310 of FIG. 3A may represent embodiments of MT 100 shown in FIGS. 1A-B. As shown in FIG. 3A, the internal MT 305 may be configured to initiate a call to the external MT 310 by calling the telephone number of the external MT 310. Since, the shared line module 140 of the internal MT 305 knows its status as being “internal”, the internal MT 305 may transmit a first INVITE message to the NAP 200 to initiate the call to the external MT 310. This INVITE message contains the address (e.g., external@provider.net) of the external MT 305 and a first call identification (CID), which identifies a first VoIP session between the internal MT 305 and the NAP 200, in step 315.

In step 320, the B2BUA module 235 of the NAP 200 may process the received first INVITE message and transmit a second INVITE message to the external MT 310, which includes the address (e.g., external@provider.net) of the external MT 310 and a second CID to establish a second VoIP session between the NAP 200 and the external MT 310, in step 325. In effect, the B2BUA module 235 may be maintaining two different sessions for the call between the internal MT 305 and the external MT 310.

In step 325, the external MT 310 receives the second INVITE message from the NAP 200 and responds with RESPONSE message acknowledging the received INVITE message in continuing to establish the second session identified by the second CID.

The NAP 200 receives the RESPONSE message and is processed by the B2BUA module 235. In step 330, the B2BUA module 235 may issue a second RESPONSE message that acknowledges the first INVITE message from the internal MT 305 to continue establishing the first session identified by first CID.

In step 335, the internal MT 305 may transmit an Acknowledgement message (“ACK” in FIG. 3A) for the first CID to the NAP 200 to establish the first session between internal MT 305 and the NAP 200. In step 340, the NAP 200 may transmit a second ACK message identifying the second CID to the external MT 310, which establishes the second session between the NAP 200 and the external MT 310. Subsequently, in step 345, the RTP packets flow between the internal MT 305 and the NAP 200 as well as between the NAP 200 and the external MT 305.

FIG. 3B illustrates an exemplary call flow diagram 350 for an external MT calling an internal MT in accordance with yet another embodiment. It should be readily apparent to those of ordinary skill in the art that the call flow diagram 350 depicted in FIG. 3B represents a generalized schematic illustration and that other call flows may be added or existing call flows may be removed or modified. Moreover, internal MT 305 and external MT 310 of FIG. 3B may represent embodiments of MT 100 shown in FIGS. 1A-B.

As shown in FIG. 3B, a user of external MT 310 may initiate a call to the internal MT by activating the “SEND” key with the number/address inputted into the external MT 310. The external MT 310 may begin to establish this call by transmitting an INVITE message to the internal MT 305in step 352. More particularly, the INVITE message identifies the address of the internal MT 305 (e.g., internal@home.net) and a first CID.

The internal MT 305 may receive the INVITE message and be processed by the shared line module 140 of the internal MT 305. Since the internal MT 305 knows its status as being “internal,” the shared line module 140 of the internal MT 305 may transmit a REDIRECT message back to the external MT 310, in step 354. The REDIRECT message contains the address of the internal MT 305 through the NAP 200 (e.g., internal@NAP.home.net). The REDIRECT message indicates to the external MT 310 to call the NAP 200 to reach the internal MT 305.

The external MT 305 receives the REDIRECT message and responds with an ACK message acknowledging the REDIRECT message, in step 356, and terminates the potential session identified by the first CID. In step 358, the external MT 310 transmits a second INVITE message that identifies the NAP 200 (e.g., internal@NAP.home.net) and a second CID to the NAP 200 to establish a session between the external MT 310 and the NAP 200. The B2BUA module 235 of the NAP 200 may process the second INVITE message and transmit a third INVITE message that identifies the internal MT (e.g., internal@home.net) and a third CID to establish a second session between the NAP 200 and the internal MT 305, in step 360.

The internal MT 305 may respond to the third INVITE message with a first RESPONSE message that accepts the third INVITE message to the NAP 200 to establish the second session identified by the third CID, in step 362. The B2BUA module may process the received first RESPONSE message from the internal MT 305 and transmit a second RESPONSE message to the external MT 310 that accepts the second INVITE message to continue establishing the first session identified by the second CID, in step 364.

The external MT 310 may receive the second RESPONSE message and is processed by the B2BUA module 235. The external MT 310 may transmit a first ACK message in response to the received second RESPONSE message that establishes the first session identified by the second CID between the external MT 310 and the NAP 200, in step 368. In turn, the B2BUA module 235 of the NAP 200 may transmit a second ACK message to the internal MT 305 that acknowledges the establishment of the second session identified by the third CID, in step 368. Accordingly, the B2BUA 235 of the NAP 200 may manage the RTP packets flow between the internal MT 305 and the NAP 200 as well as between the NAP 200 and the external MT 305 as two separate calls, in step 370.

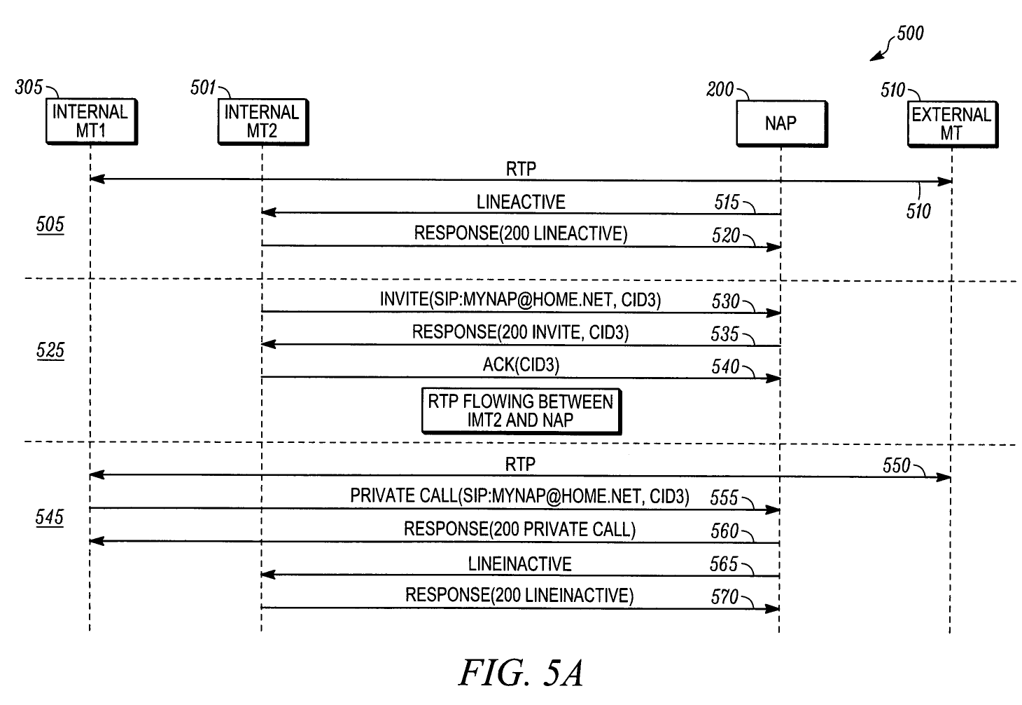

FIG. 4 illustrates an exemplary system 400 in accordance with another embodiment. It should be readily apparent to those of ordinary skill in the art that the system 400 depicted in FIG. 4 represents a generalized schematic illustration and that other components may be added or existing components may be removed or modified. Moreover, the system 400 may be implemented using software components, hardware components, or combinations thereof.

As shown in FIG. 4, the system 400 includes access cells 405. The access cells 405 may interface with an Internet Protocol (“IP”) network 415. The IP network 415 may be the internet, a private local area network, a private wide area network, or combinations thereof. The IP network 415 may also interface with the public switched telephone network 410 (labeled as PSTN in FIG. 4) through a SIP/media gateway 411, which is configured to convert PSTN signals and/or media into respective VoIP signals and/or media and vice a versa.

Each access cell may include an enhanced base transceiver station 420 (labeled as “EBTS”). The EBTS 420 may be configured to transmit and receive voice packets from mobile terminals 100 within the coverage area of the EBTS 420. The EBTS 420 may also include a service integration module (not shown) that is configured to determine the current state of each mobile terminal in the coverage area of the EBTS 420.

The EBTS 420 may interface with an interconnect call module 425 and a SIP call module 430. The interconnect call module 425 may include a base site controller (labeled as BSC) 435 coupled with a mobile switching center (labeled as MSC) 440 for handling cellular and circuit switched calls. The MSC 435 may also be interfaced with a home location and visitor location registers (not shown) for providing mobility management as known in the art. The BSC 440 can provide control and concentration functions for one or more EBTS sites and their associated mobile terminals 100.

The SIP call module 430 may include a Serving GPRS Support Node (labeled as SGSN) 445 interfaced with a home subscriber server (“HSS”) 450 for processing SIP calls and packet data. The HSS 450 may also be interfaced with home location and visitor location registers (not shown) for providing mobility management as known in the art. The HSS 450 may also be referred to as VLR or HLR. In the case of packet data, the SGSN 445 can route such packet data via a GPRS Gateway Support Node (labeled as GGSN) 455 to the IP network 415 through a second SIP/media gateway 460.

System 100 may further include a domain name server (labeled DNS) 465 and a SIP server 470. The DNS 465 may be configured to provide DNS services as known to those skilled in the art. The SIP server 470 may be configured to provide the call services for SIP-based calls between the mobile terminals 100.

The system 400 may also include an internal zone 475 interface with data network. The internal zone 475 may be a home, an office, or other similar entity. The internal zone 475 may be defined as the coverage area of the NAP 200. For MTs 100 within the internal zone 475, these mobile terminals may be referred to as internal MTs. Each internal MT may be configured to initiate and receive VoIP calls through the NAP 200. However, if the NAP 200 is managing a VoIP call, the other internal MT may dial directly to a destination or join the existing VoIP call. The NAP 200 may also interface with a data network 480.

The data network 480 may be local area network, wide area network or combination thereof. The data network 480 may be maintained by a third party providing Internet services to the internal zone 475. The data network 480 may also be configured to interface with the IP network 415.

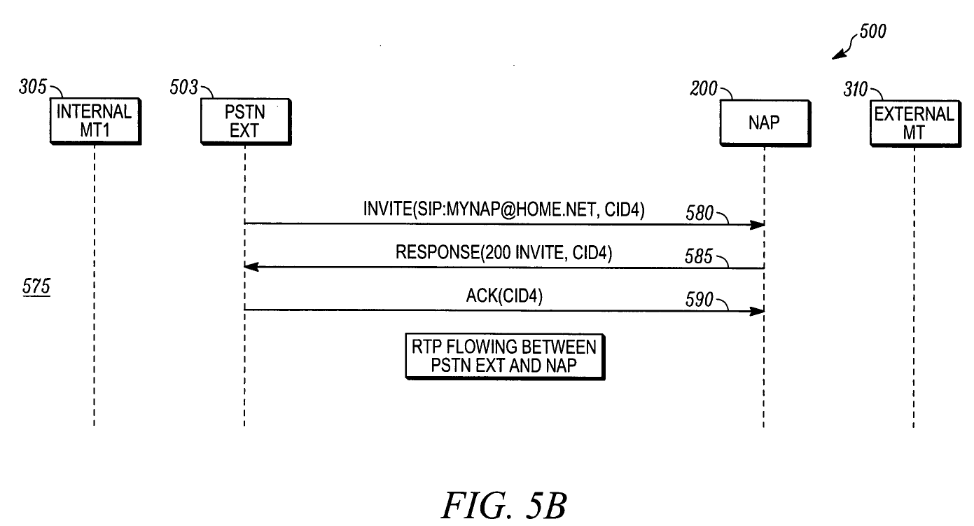

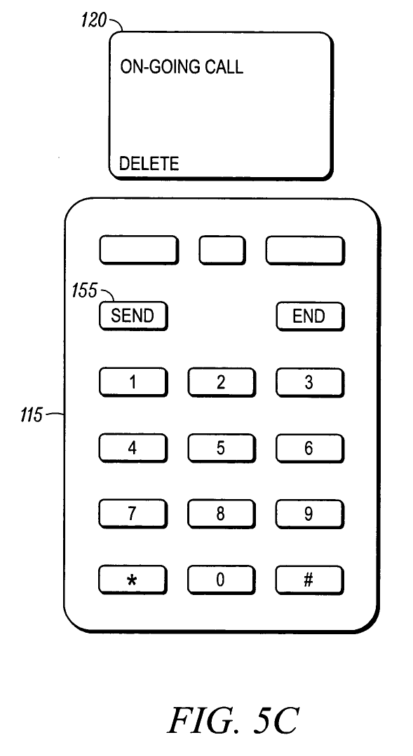

FIGS. 5A-B illustrates an exemplary call flow diagram 500 in accordance with another embodiment. It should be readily apparent to those of ordinary skill in the art that the call flow diagram 500 depicted in FIGS. 5A-B represents a generalized schematic illustration and that other call flows may be added or existing call flows may be removed or modified.

Generally, sequence 505 illustrates the call flow for a second internal MT2, to join existing calls between internal MT1 and an external MT through the NAP 200. The on-going calls between internal MT1 and the external MT may have established VoIP connections through the NAP 200 in accordance with the call flows described with respect to either FIG. 3A or FIG. 3B. Voice/data packets may be flowing between the parties in accordance with RTP, in step 510.

The B2BUA module 235 of the NAP 200 may transmit a LINEACTIVE message to the other internal MTs (e.g., internal MT2 501) in the internal zone 475, in step 515. More particularly, once the B2BUA module 235 of the NAP 200 has established both session, i.e., the call between the internal MT1 and the NAP 200 and the call between the NAP 200 and the external MT 310, the B2BUA module 235 may issue this message. The LINEACTIVE message notifies the internal MT2 501 that a call exists and may be joined.

FIG. 5C illustrates an exemplary user interface 215 and display 220 after establishment of the on-going calls for the internal MT2. FIG. 5C is similar to FIG. 1B, the description of the common elements are being omitted and that the descriptions of these features with respect to the first figure being relied upon to provide adequate descriptions of the common features. As shown in FIG. 5C, the display 120 displays a message (“ON-GOING CALL”) that on-going calls between the internal MT1 305 and the external MT 310 are occurring. The user of internal MT2 501 may join the on-going calls by activating the SEND key 155 (or a predefined soft key, another key, a key combination or other predefined user input). Alternatively, the user of internal MT2 may directly dial another external mobile terminal by entering that phone number into the user interface 115.

Returning to FIG. 5A, the LINEACTIVE message may also indicate to the other internal MT2 501 to reset the “SEND” key of the user interface (e.g., SEND key 155 shown in FIG. 1B) to the address/number (e.g., myNAP@home.net) of the NAP 200. Thus, a user of internal MT2 501 may seamlessly join the call between internal MT1 305 and the external MT 310. In step 520, the internal MT2 may transmit a RESPONSE message to the NAP 200. The RESPONSE message acknowledges the received LINEACTIVE message.

Sequence 525 generally illustrates the internal MT2 501 joining existing calls between internal MT1 305, the NAP 200, and the external MT 310. A user of internal MT2 may wish to join the existing calls established in step 510 by activating the SEND key 155 on the user interface 115 of the internal MT2 501. The internal MT2 501 may transmit an INVITE message to the NAP 200, in step 530. The INVITE message includes information such as the address of the NAP 200 (e.g., mynap@home.net) and a third CID, which indicates that a third VoIP connection or session is to be established between the internal MT2 501 and the NAP 200.

In step 535, the B2BUA module 235 of the NAP 200 responds with a RESPONSE message which acknowledges the received INVITE message and the third CID to the internal MT2 501 to continue establishing the third session. Subsequently, in step 540, the internal MT2 501 transmits an ACK message to the NAP 200 acknowledging the establishment of the third VoIP session identified by the third CID. Accordingly, RTP packets may then flow between the internal MT2 501, the NAP 200, the internal MT1 305 and external MT 310 through three different VoIP sessions.

Sequence 545 generally depicts the internal MT 305 initiating a privacy mode for the call that comprises of the session between the internal MT1 305 and the NAP 200 and the session between the NAP 200 and the external MT 310. The sessions may have been established in accordance with the call flows described with respect to either FIG. 3A or FIG. 3B. Voice/data packets may be flowing between the parties in accordance with RTP, in step 550.

A user of internal MT1 may wish to make the call to the external MT 310 private, i.e., prevent other internal mobile terminals (e.g., internal MT2 501) to join the call. Accordingly, in some embodiments, the user of internal MT1 may enter a private mode by activating a privacy mode button on the user interface 115 of the internal MT1 305. The shared line module 140 of the internal MT 305 may then transmit a PRIVATE CALL message to the NAP 200, in step 555. More specifically, the PRIVATE CALL message contains the address of the NAP 200 (“myNAP@home.net”) and a third CID. The third CID indicates to the B2BUA module 235 not to accept anymore additional calls to the existing calls.

In step 560, the B2BUA module 235 of the NAP 200 may issue a RESPONSE message acknowledging the received PRIVATE CALL message to the internal MT 305. Subsequently, the B2BUA module 235 may issue a LINEINACTIVE message to the internal MT2 501. The LINEINACTIVE message indicates to the other internal mobile terminals within the coverage zone of the NAP 200 that the on-going calls cannot be shared, i.e., private. Accordingly, the internal mobile terminals which received the LINEINACTIVE message reset their “SEND” key and the display 120 (shown in FIG. 5C) to their default settings. In step 570, the internal MT2 501 returns a RESPONSE message that acknowledges the received LINEINACTIVE message.

Sequence 575 generally illustrates a PSTN telephone joining on-going calls between internal MT1 305 and external MT 310. In some embodiments, the PSTN telephone (labeled as PSTN EXT in FIG. 5B) 503 may be connected to the ATA adapter 230 of the NAP 200. In step 580, the PSTN telephone 503 may go off-hook, which transmits an INVITE message to the NAP 200 to establish another call or session to the existing sessions. The INVITE message indicates the address of the NAP 200 and a fourth CID identifying a fourth session to be established if the on-going call involves internal MT 305, internal MT 501, the NAP 200 and the external MT 310.

In step 585, the NAP 200 may respond with a RESPONSE message acknowledging the received INVITE message to continue establishing the fourth session to the PSTN telephone 503. Subsequently, in step 590, the PSTN telephone 503 transmits an ACK message acknowledging the received RESPONSE message. This establishes the fourth VoIP session between the PSTN telephone 503 and the NAP 200 and RTP packets may then flow between all the parties.

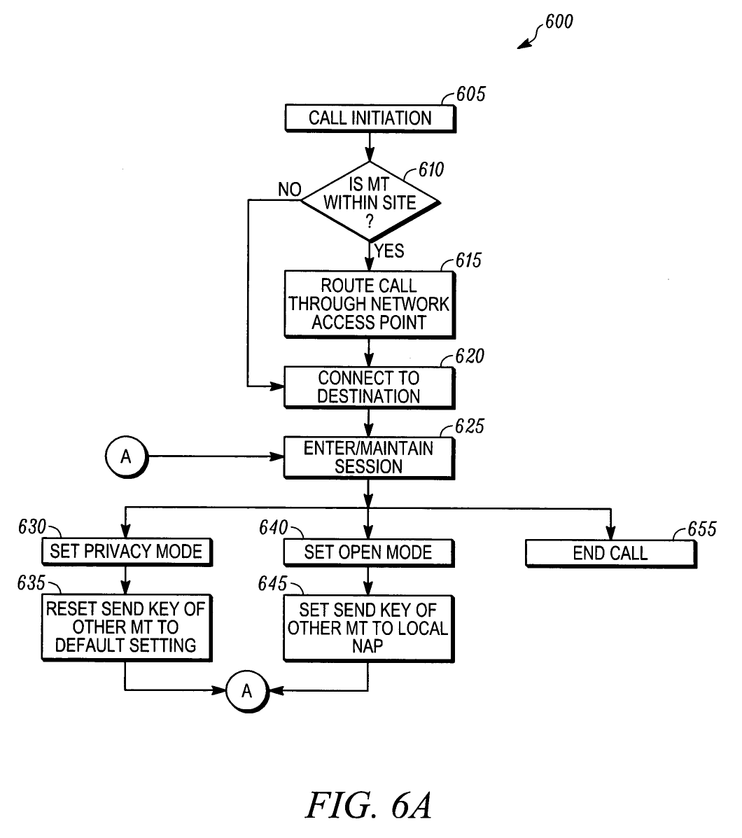

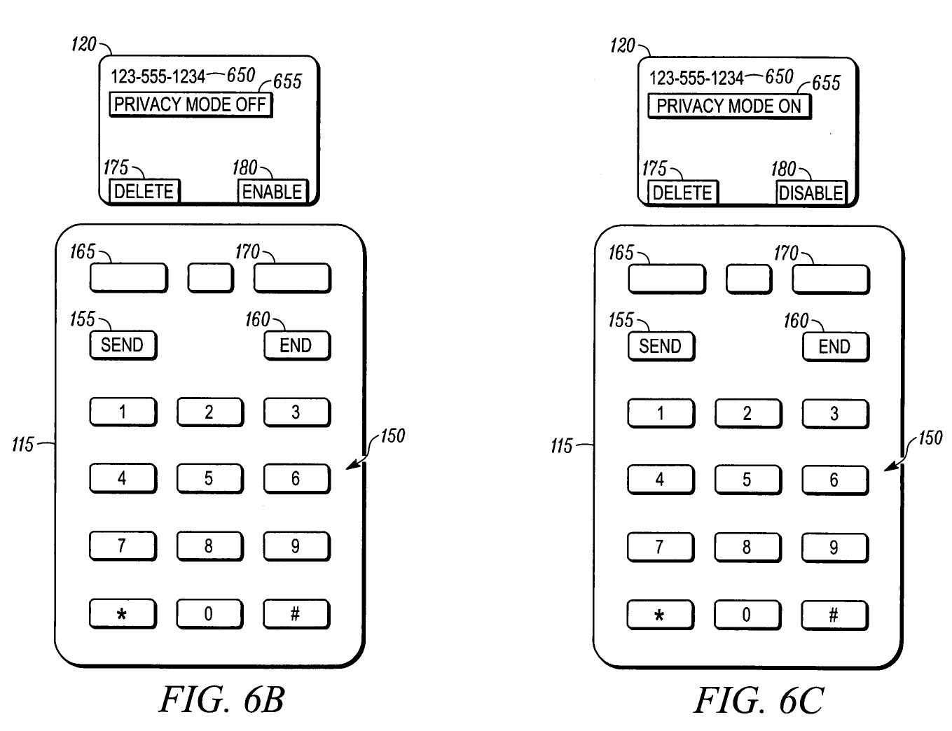

FIG. 6A illustrates a flow diagram 600 for the shared line module 140 in accordance with yet another embodiment. It should be readily apparent to those of ordinary skill in the art that the flow diagram 600 depicted in FIG. 6A represents a generalized schematic illustration and that other components may be added or existing components may be removed or modified.

As shown in FIG. 6A, the shared line module 140 executing on the MT 100 may be configured to monitor when a user initiates a VoIP call. When the user activates the “SEND” key on the user interface 215 of MT 100, in step 605, the shared line module 140 may be configured to determine whether the MT 100 is within a coverage zone of a NAP, i.e., internal status, in step 610.

If the status of the MT 100 is internal, the shared line module 140 may be configured to redirect the call from an external MT to the NAP 200 using a REDIRECT command from the SIP protocol, in step 615. In step 620, the shared line module 140 may transmit a message for the B2BUA module 235 to connect the internal MT 100 with the external MT as previously described with respect to FIG. 3A. In step 625, the MT and the external MT may enter a VoIP session where voice packets are transmitted between both parties according to RTP.

While in the VoIP session or call, the user may be configured to set a privacy mode, in step 630. The privacy mode as implemented by the shared line module 140 prevents other mobile terminals or PTSN telephones from joining the VoIP call between MT 100 and the external MT. FIG. 6B illustrates an exemplary user interface 215 and display 220 after establishment of the on-going call. FIG. 6B is similar to the FIG. 1B, the description of the common elements are being omitted and that the descriptions of these features with respect to the first figure being relied upon to provide adequate descriptions of the common features. As shown in FIG. 6B, the number of the external MT may be displayed in field 650. Privacy mode field 655 may display the current status of the on-going call. For this figure, the default setting is “PRIVACY MODE OFF”. Programmable field 180 may have a value of “ENABLE” associated with programmable key 175. Accordingly, if a user activates the programmable key 175, which enables the privacy mode for the on-going call, the display 120 changes display shown in FIG. 6C. As shown in FIG. 6C, the privacy mode field 655 displays the status of the on-going call as being “PRIVACY MODE ON.” The programmable field 180 has been changed to “DISABLE”. Thus, a user may activate programmable key 1.70 to disable the privacy mode for the on-going call.

Returning to step 630 of FIG. 6A, one of the users in the on-going VoIP call may activate the privacy mode by activating “ENABLE” key 170 on the user interface 115 as shown in FIG. 6B. The activation of the privacy puts the on-going VoIP call into a private mode where other MTs that have the internal status cannot join the call. The shared line module 140 of the MT that initiated the private mode to send a message to the NAP 200 indication of the private mode initiation. The NAP 200 may be configured to send a notification message to the other MTs in the coverage zone that resets their respective “SEND” key to the default setting, i.e., the user has to enter a phone number to dial out, in step 635. Subsequently, the shared line module 140 may return to step 625 to continue with the session.

While in the private mode, a user may exit out of the private mode by activating the “DISABLE” key 170 as shown in FIG. 6C, in step 640. The activation of the “Privacy” key 170 while in the private mode may return the on-going VoIP call to a shared or open mode. The shared line module 140 of the MT that initiated the shared mode to send a message to the NAP 200 indicating the initiation of the shared or open mode. The NAP 200 may be configured to send a notification message to the other MTs in the coverage zone that resets their respective “SEND” key to the number/address of the NAP 200, in step 645. Accordingly, other MT may then seamlessly join the on-going VoIP call between MT and an external MT. Subsequently, the shared line module 140 may return to the on-going call in step 625.

While in the on-going call or session, in step 625, a user may depress the END key 160, in step 655, which terminates the call.

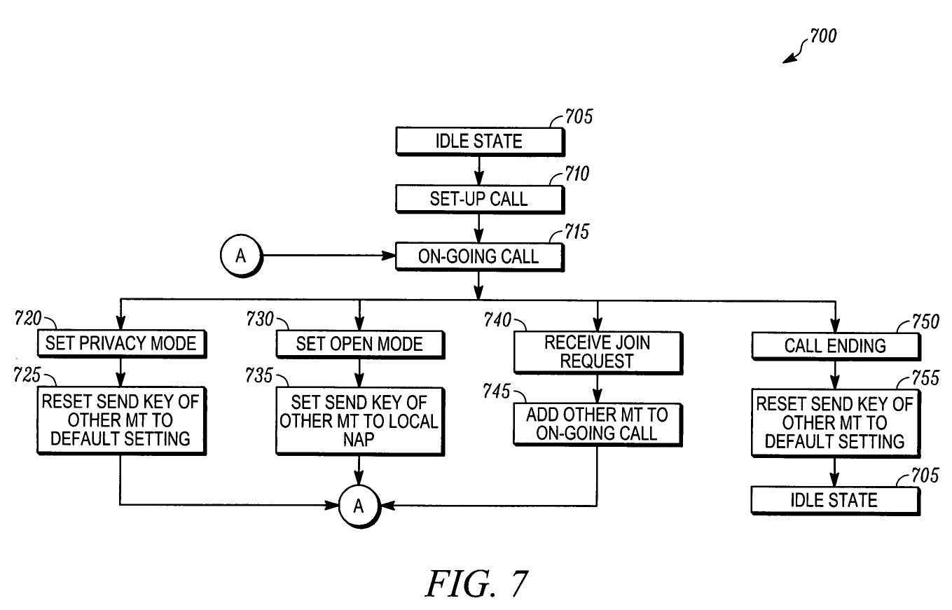

FIG. 7 illustrates a flow diagram 700 implemented by the NAP 200 in accordance with another embodiment of the invention. It should be readily apparent to those of ordinary skill in the art that the flow diagram 700 depicted in FIG. 7 represents a generalized schematic illustration and that other components may be added or existing components may be removed or modified.

As shown in FIG. 7, the NAP 200 may be configured in an idle state, in step 705. The NAP 200 may be configured to service a location such as a home, an office, a building, or other similar entity. In step 710, the NAP 200 may be configured to receive a message from the internal MT to connect with an external MT or external telephone. The NAP 200 may be configured to set up the call as previously described with respect to FIGS. 3A-B. The NAP 200 may then be configured to pass data, voice, and command packets between the parties in an on-going call/session, in step 715.

While in a session or conversation exists, at least four events may occur for the NAP: (a) one of the MTs may enable the privacy mode; (b) one of the MTs may disable the privacy mode; (c) another internal MT and/or PSTN telephone may join the on-going call; and (d) one of the MTs may terminate the session. It should be readily obvious to one skilled in the art that other events may occur such as placing a call on hold, sending a picture, etc., without departing from the scope and breadth of the embodiments.

In some embodiments, the VoIP call between an internal MT and an external MT may be configured to in an open mode, i.e., other internal MT may join the call. If one of the users of the MTs activates or enables the privacy mode, for example, activating the ENABLE key 170 in FIG. 6B, the NAP 200 may receive a message that the privacy mode has been set, in step 720. The message may be formatted in accordance with SIP protocols. The NAP 200 may be configured to prevent any other internal MTs from joining the VoIP call.

In step 725, the NAP 200 may be configured to send a reset message to the other internal MTs within the coverage area of the NAP 200. More specifically, the reset message indicates to the MTs that they are to reset the “SEND” key 165 to their default, i.e., a user has to input a phone number for a call. The NAP 200 may then return to maintaining the on-going call of step 715.

While in the privacy mode for a VoIP call, one of the users may disable the privacy mode as described with respect to FIG. 6C, the NAP 200 may receive a message that the status of the on-going VoIP call has been set to a shared or open mode, in step 730. This message may also be configured to be formatted according to SIP protocols and informs the NAP 200 to allow other internal MTs to join the existing VoIP call.

In step 735, the NAP 200 may be configured to send another message that programs the “SEND” key 165 of the other internal MTs to default to the number/address of the NAP 200. Accordingly, the other internal MTs may seamlessly join the on-going call. Subsequently, the NAP may return the on-going call, in step 715.

The NAP 200 may also receive a request by a second internal MT or PSTN extension to join the on-going call, in step 740, as described with respect to FIG. 5. More specifically, a user of a second internal MT activated its “SEND” key (or a predefined soft key, another key, a key combination or other predefined user input) or the PSTN telephone goes off-hook. In step 745, the NAP 200 may join the new party to the on-going call as previously described with respect to FIG. 5. Subsequently, the NAP 200 may return to the on-going call in step 715.

The NAP 200 may receive an indication that a call is ending, in step 750. More particularly, one of the users in the on-going call has depressed the “END” key 165. In step 755, the NAP 200 may be configured to send a reset message to the other internal MTs within the coverage area of the NAP 200. More specifically, the reset message indicates to the MTs that they are to reset the “SEND” key to their -default, i.e., a user has to input a phone number for a call. Subsequently, the NAP 200 may return to the idle state of step 705.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of joining a call, the method comprising:
establishing the call between an internal mobile terminal (MT), an external MT, and a network access point (NAP), wherein the call comprises a connection between the internal MT and the NAP and a second connection between the NAP and the external MT;
sensing the call by a second internal MT; and
joining the call from the second internal MT by depressing a send key without entering a number on the second internal MT.

2. The method of claim 1, wherein the establishment of the call between the internal MT, external MT and the NAP further comprises:
initiating the call from the internal MT to the external MT;
redirecting the call from the external MT to the NAP; and
establishing a first connection between the internal MT and the NAP.

3. The method of claim 2, further comprising:
initiating a second call from the NAP to the external MT in response to the establishment of the connection between the internal MT and the NAP; and
establishing a second connection between the NAP and the external MT.

4. The method of claim 3, further comprising operating the NAP as a back-to-back user agent.

5. The method of claim 1, wherein the establishment of the call between the internal MT, external MT and the NAP further comprises:
receiving the call at the internal MT from the external MT;
redirecting the call from the external MT to the NAP; and
establishing a first connection between the external MT and the NAP.

6. The method of claim 5, further comprising:
initiating a second call from the NAP to the internal MT in response to the establishment of the connection between the external MT and the NAP; and
establishing the second connection between the NAP and the external MT.

7. The method of claim 5, further comprising operating the NAP as a back-to-back user agent.

8. The method of claim 1, further comprising initiating a privacy mode configured to prevent other MTs from joining the call.

9. The method of claim 1, further comprising:
determining whether any MTs are within range of the NAP; and
setting the NAP as a default call in response for the MTs being within range of the NAP.

10. An apparatus comprising of means to perform the steps of claim 1.

11. A computer readable medium comprising of executable code for performing the steps of claim 1.

12. A system for sharing a line in a voice over Internet Protocol (VoIP), the system comprising:
a network access point (NAP) within a site;
a plurality of internal mobile terminals (MTs) located within the site and within the range of the NAP, each MT configured to communicate using VoIP; and
at least one external MT configured to communicate using VoIP; wherein the system is configured to establish a call between a first internal MT and the at least one external MT through the NAP, setting a send key to call the NAP in each of the rest of the plurality of internal MT in response to the establishment of the call and joining a second internal MT to the call in response to depressing the send key of the second internal MT.

13. The system of claim 12, wherein the call comprises a first connection to the first internal MT to the NAP and a second connection between the NAP and the at least one external MT.

14. The system of claim 12, wherein the NAP is configured to operate as a back-to-back user agent.

15. The system of claim 12, wherein the call establishes a privacy mode that prevents the rest of the plurality of internal MTs from joining the call.

16. A handset configured for sharing a line in a voice over Internet Protocol (VoIP) system, the handset comprising:
a transceiver configured to interface with an access cell of a mobile communication system and a network access point;
a user interface with a transmit key; and
a processor configured to execute a shared line module, the processor is configured to determine from the NAP that a call-in-progress, setting the NAP as a default number for the transmit key, and joining the call-in-progress in response to activating the transmit key.

17. The handset of claim 16, wherein the processor is further configured to configured to form a connection to the NAP to join the call-in-progress.

18. The handset of claim 16, wherein the processor is further configured to determine whether the handset is within a range of the NAP and setting an in-location status.

19. The handset of claim 18, wherein the processor is further configured to redirect any incoming calls to the NAP in response to the in-location status being set.

20. The handset of claim 18, wherein the processor is further configured to receive an outgoing telephone number on the user interface and redirect to the outgoing telephone number to the NAP in response to the in-location status being set.

21. The handset of claim 16, wherein the processor is further configured detect a privacy mode being enabled for the call-in-progress and prevent the setting of the NAP as the default number for the send key.
